(19) United States
(12) Patent Application Publication
(10) Pub. No.: US 2017/0185652 A1
(43) Pub. Date: Jun. 29, 2017

(54) BIAS CORRECTION IN CONTENT SCORE

(71) Applicant: International Business Machines Corporation, Armonk, NY (US)

(72) Inventors: Leonid Bolshinsky, Karmiel (IL); Vladimir Gamaley, Rehovot (IL); Sharon Krisher, Haifa (IL)

(21) Appl. No.: 15/455,204

(22) Filed: Mar. 10, 2017

Related U.S. Application Data
(63) Continuation of application No. 14/927,815, filed on Oct. 30, 2015.

(51) Int. Cl. G06F 17/30

(52) U.S. Cl. CPC G06F 17/30528; G06F 17/3053; G06F 17/30554

(57) ABSTRACT

One or more processors reduce bias in a score of a content. The one or more processors determine a predicted pattern of behavior of a user that provided a portion of data used to generate an initial rating of content. The one or more processors generate a modified rating of the content based on a degree of matching between the predicted pattern of behavior of the user and an action of the user that provided the portion of data.

### BACKGROUND OF THE INVENTION

The present invention relates generally to the field of providing recommendations, and more particularly to bias correction.

Internet-based social networking services provide a digital medium for users to interact with one another and to share information. For example, users are able to distribute digital content (e.g., posts including textual comments, digital images, digital videos, digital audio, hyperlinks to network-accessible documents, etc.) to other users that they might be connected to within the social networking service. Digital content that is distributed to a user can be displayed to the user automatically in a content stream in a home (or “stream”) page, and/or in response to a user query in a search results page.

A social networking system typically has access to large amount of social information and content provided by users that may be of interest to other users of the social networking system. A user is likely to be interested in learning about content provided by other users connected to the user in the social networking system. This content can include, photo uploads, status updates, transactions, wall posts, posting of comments, recommendations, approval indications, and the like. The social networking system often stores various ratings for content provided by users as well as logs of the activities of users. For example, an activity related to a social group and event is represented in the social networking system as have a “like” rating associated with it, wherein users in the social group have indicated there like or dislike of that activity, thereby yielding an overall “like” score for that activity.

In the growing world of social networks, content is often evaluated using aggregated sentiment and feedback regarding that content. Users are typically provided with an option of leaving feedback regarding an aspect of a particular online content. Users then provide their opinions, which are combined to generate a score for that content. For example: number of likes, number of sharing actions between the users, average numerical score (or stars) which the user can assign to it etc.

As such, the overall score representing the content is an average of user provided sentiment and feedback. The more sentiment and feedback that is used for such determinations the more likely it is that the score is actually representative of some aspect related to the content, such as usefulness, popularity, etc. As the amount of feedback continues to shrink, the likelihood of a single user's feedback biasing the score increases in likelihood. Feedback-based systems continue to face challenges in providing accurate scores.

### SUMMARY

Viewed from a first aspect, the present invention provides a method for reducing bias in a score of a content. One or more processors determine a predicted pattern of behavior of a user that provided a portion of data used to generate an initial rating of a first content. The one or more processors generate a modified rating of the first content based, at least in part, on a degree of matching between the predicted pattern of behavior of the user and an action of the user that provided the portion of data. Advantageously, this invention introduces a way of reducing the effect of bias on a rating associated with a particular content.

In some embodiments of the first aspect, one or more processors generate the predicted pattern of behavior of the user based on one or more of i) a social relationship of the user, ii) a level of expertise of the user, and iii) a history of behavior of the user regarding a second content. Advantageously, such embodiments of the present invention use a history of activity, social relationships, and expertise of a user to identify a degree of bias associated with an action of a user that is associated with a particular content.

In some embodiments of the first aspect, the one or more processors determine a search result based, at least in part, on the modified rating of the first content. Advantageously, some such embodiments provide search results that are not identified during a search based on content that has an un-modified rating, i.e., the original rating based on user actions. Advantageously, some such embodiments provide an order of search results that is different from the order of search results that is based on content that has an un-modified rating, i.e., an order of search results using the original rating based on user actions.

In some embodiments of the first aspect, the modified rating of the first content has a lower degree of bias when compared to a degree of bias inherent to the initial rating of the first content. Advantageously, some such embodiments of the present invention provide one or both of i) a reduction in a degree of bias for a rating of a content increases the accuracy of that rating and ii) an increase in the reliability of that rating. In some such embodiments, ratings with a higher degree of accuracy and/or reliability have the advantage of increasing the likelihood of returning a search result that provides the content being searched for by a user.

Viewed from a second aspect, the present invention provides a computer system for reducing bias in a score of a content. The computer system includes program instructions for execution by one or more processors. By executing the program instructions, the one or more processors determine a predicted pattern of behavior of a user that provided a portion of data used to generate an initial rating of a first content. By executing the program instructions, the one or more processors generate a modified rating of the first content based, at least in part, on a degree of matching between the predicted pattern of behavior of the user and an action of the user that provided the portion of data. Advantageously, this invention introduces a way of reducing the effect of bias on a rating associated with a particular content. Advantageously, embodiments of the present invention use a history of activity of a user to identify a degree of bias associated with an action of a user that is associated with a particular content.

Viewed from a third aspect, the present invention provides a program product for reducing bias in a score of a content. The computer program product includes program instructions for execution by one or more processors. By executing the program instructions, the one or more processors determine a predicted pattern of behavior of a user that provided a portion of data used to generate an initial rating of a first content. By executing the program instructions, the one or more processors generate a modified rating of the first content based, at least in part, on a degree of matching between the predicted pattern of behavior of the user and an action of the user that provided the portion of data. Advantageously, this invention introduces a way of reducing the effect of bias on a rating associated with a particular content. Advantageously, embodiments of the present invention use a history of activity of a user to identify a degree of bias associated with an action of a user that is associated with a particular content.

### BRIEF DESCRIPTION OF THE SEVERAL VIEWS OF THE DRAWINGS

FIG. 1 is a functional block diagram illustrating a content evaluation environment, in accordance with an exemplary embodiment of the present invention.

FIG. 2 illustrates operational processes of a biasing program, executing on a computing device within the environment of FIG. 1, in accordance with an exemplary embodiment of the present invention.

FIG. 3 depicts a block diagram of components of the computing device executing the biasing program, in accordance with an exemplary embodiment of the present invention.

### DETAILED DESCRIPTION

While known solutions to scoring an aspect of an internet content are known, they rely on an average of user feedback. Embodiments of the present invention recognize that unless there is a substantial amount of such feedback, the average can be biased by a relatively small amount of feedback. Embodiments of the present invention recognize that some users consistently give higher or lower scores than other users. Embodiments of the present invention recognize that some users consistently give higher or lower scores to certain types of content than other users. Embodiments of the present invention provide a reduction to the amount of bias that results from a given user feedback. Embodiments of the present invention recognize that historical feedback can be used to predict how a given user will respond when queried for feedback. Embodiments of the present invention provide recognition for feedback that does not conform to a predicted pattern of feedback provided by a given user. Embodiments of the present invention provide an adjustment to an overall score of content based on the degree of predictability of user feedback that is provided for that content. Embodiments of the present invention provide a biasing of a value provided as part of a user feedback. Embodiments of the present invention provide a degree of weighting or otherwise altering user feedback (such as for example, a vote caste by a user, or a user provided numerical rating) such that a known or predicted degree of bias of the user provided feedback is reduced.

For the purposes of clarification and ease of understanding, hereinafter are discussed three exemplary embodiments of the present invention. One such embodiment is configured as a content ranking program. Another such embodiment is configured as a search engine. The third such embodiment is configured as a social media website.

The present invention will now be described in detail with reference to the Figures.

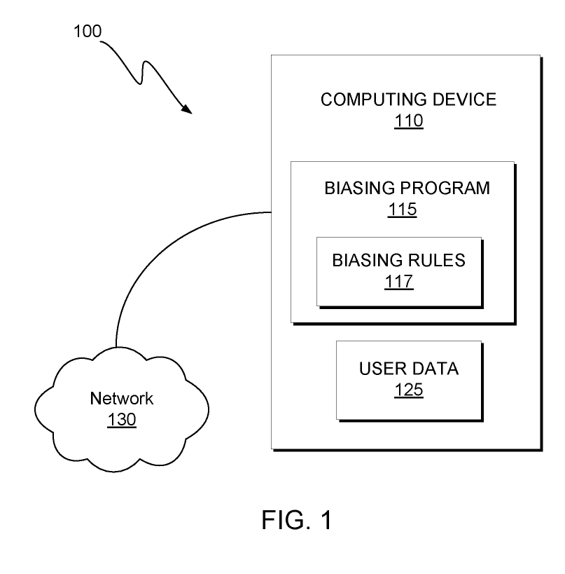

FIG. 1 is a functional block diagram illustrating content evaluation environment, generally designated 100, in accordance with one embodiment of the present invention. Content evaluation environment 100 includes computing device 110 connected to network 130. Computing device 110 includes biasing program 115 and user data 125.

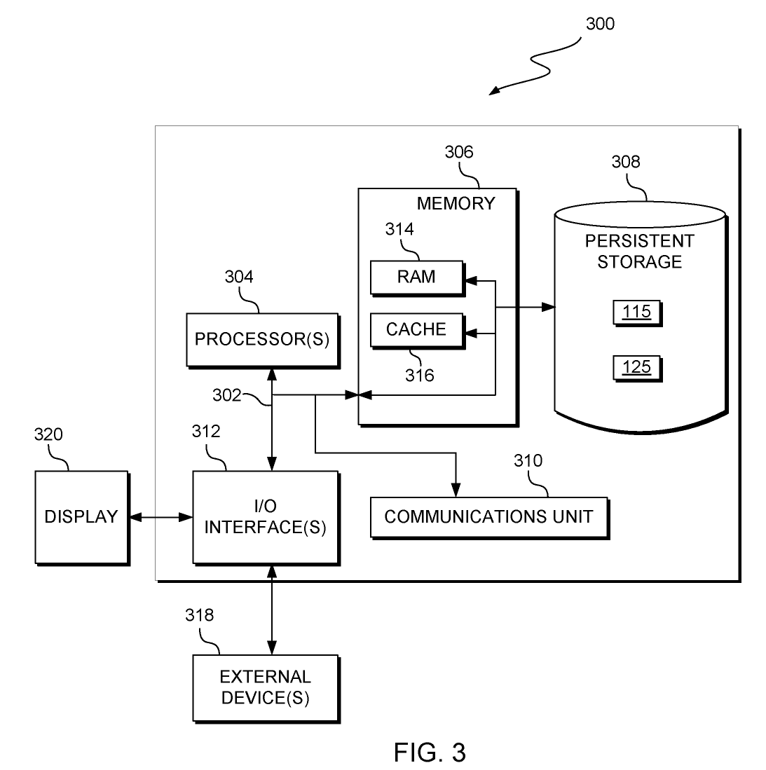

In various embodiments of the present invention, computing device 110 is a computing device that can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to biasing program 115 and user data 125 and is capable of executing biasing program 115. Computing device 110 may include internal and external hardware components, as depicted and described in further detail with respect to FIG. 3.

In one exemplary embodiment, biasing program 115 and user data 125 are stored on computing device 110. However, in other embodiments, biasing program 115 and user data 125 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110, biasing program 115, and user data 125, in accordance with a desired embodiment of the present invention.

In the growing world of social networks, the content quality is often evaluated by the aggregated amount of positive emotions the content has. For example: number of likes, number of sharing actions between the users, average numerical score (or stars) which the user can assign to it etc.

A potential disadvantage of that approach is that is does not differentiate between the same actions results received from different users. For example, there may be users who often or routinely add indications of approval for on-line content that they choose to access, e.g., documents they read and images they view. In another example, there are users who will typically provide positive responses and feedback when some content is shared with them directly by other users regardless of their evaluation of the content, because, for example, they wish to encourage relationships with the other users. In another example, there are users who provide random feedback instead of informed feedback regarding a given topic because they have no applicable knowledge related to that topic. The challenge of reducing bias in the content score due to biased feedback is addressed herein. Certain embodiments of the present invention have the advantage of being able to reduce bias from a particular piece of data using a behavioral profile for a user that provided that data. Some embodiments of the present invention have the advantage of being able to produce search results with an improved accuracy as a result of such reduced bias. Some embodiments of the present invention have the advantage of being able to modify data, at least temporarily or for a specific use, based on predicted behavior for a user that provided that data.

In one exemplary embodiment, biasing program 115 is a content ranking program that is configured to provide rankings for content. The ranking is based, at least in part, on user feedback for that content, which is modified by biasing program 115 to reduce the degree of bias in the user feedback. As such, the ranking of content provided by biasing program 115 has a reduced degree of bias when compared to a ranking that is based on the original user feedback. Such ranked content is then provided to the consumers of such data by biasing program 115. In some such embodiments, a subset of the ranked content is provided to the consumer by biasing program 115. For example, the ten highest rated content is provided to the consumer by biasing program 115. In some embodiments, additional statistical data is provided along with the ranking. For example, in some embodiments statistics such as average rank, number of contents that were evaluated, standard deviation etc. are included as part of the information provided to the consumer.

In some embodiments, biasing program 115 takes a biased feedback for a content and weights that feedback, using biasing rules 117; such the bias of that feedback is reduced. In some embodiments and scenarios, biasing program 115 takes the now re-biased feedback and uses it to evaluate the content. In some embodiments, biasing program 115 uses such evaluated content to provide search results and other organizations of content. As such, one exemplary embodiment of biasing program 115 is included as part of a search engine that provides search results based on modified rating. In some such embodiments, the search results are ranked or otherwise organized based, at least in part, on the modified rankings.

In general, biasing rules 117 is a set of rules that dictate how biasing program 115 applies the data included in user data 125 to weight, i.e., re-bias, a rating provided by a given user. In some embodiments, the type and number of rules used by biasing program 115 varies according to the type of rating. For example, an incremented rating system of 1-5 stars would use a different set of weighting rules, than another rating system that only includes two options of either “like” or “dis-like.”

Other rules included in biasing rules 117 are configured for use by biasing program 115 to determine relationships between users, actions, and content. Some of these rules are used to determine an overall modified rating for a particular content. In contrast, other rules are used specifically to determine the degree of bias that results from a type of relationship. For example, a close friend will have a different degree of bias associated with it than a more distant acquaintance. As such, biasing rules 117 includes rules that are configured to determine the degree of closeness between two friends as well as the degree of influence their level of closeness has on a given type of rating. One skilled in the art recognizes that there are many possible types of rules that can be included as part of biasing rules 117 as well as many approaches to the implementation of those rules when correcting the bias present in a given feedback/opinion regarding a particular content.

In some embodiments, biasing program 115 differentiates the score of the user actions (like, dislike, share etc.) according to one of their social relationships, their known areas of expertise, and their behavioral profile.

In some embodiments, biasing program 115, when content consumer (reader) is performing some action on the content, biasing program 115 evaluates the action from a social perspective. In some embodiments, biasing program 115 assigns a smaller score to actions (like, share etc.) if a user performs those actions on a regular basis, as determined based on a known pattern of user behavior. In contrast, in some embodiments, biasing program 115 assigns higher scores to actions performed by users who seldom perform such actions. In some embodiments, biasing program 115 increases the score of an action if that action is not included in a predicted pattern of behavior.

In some embodiments, biasing program 115 assigns a higher score to an action if it is a) performed by an expert in that topic, and b) the action is performed on a piece of content that is associated with that topic.

In some embodiments, biasing program 115 assigns a higher score to positive actions, which are performed by strangers (as opposed to people who know the author of the content). In some embodiments, biasing program 115 gives higher negative score to negative actions (dislike, low grade) that are performed by close friends.

In some embodiments, for certain social networks (for example, for a hierarchically ruled organization), biasing program 115 assigns a different score to, or modifies a score, associated with actions performed by higher ranked individuals. For example, an owner of a company and a stock room clerk each give the same negative rating to a proposal. However, due to the position of the owner in the company hierarchy, biasing program 115 adds extra weight to the negative rating of the owner such that it counts more negatively toward the rating of the proposal when compared to that of the weight of the rating provided by the stock room clerk.

In exemplary embodiments, user data 125 includes a recent history of actions of each user. A profile of behavior based on this information is also included in user data 125. In some embodiments, biasing program 115 monitors and collects the historical actions of users and generates profiles of behavior for those users. In other embodiments, the collection of such data and generation of profiles of behavior are completed using one or both of other programs and computing devices, excluding computing device 110. For example, in one embodiment, the collection of such data and generation of profiles of behavior are generated using a cloud computing system.

In one embodiment, the profile for user U includes the following. i) For each type of action (A) (e.g. sharing/like/dislike), the probability p (U, A) of the user U performing that action on some item. In other words, a percentage is determined that represents the amount of content to which the user performed the action in contrast to the total amount of content that the user viewed. For example, the user ‘liked’ 70% of the content items that he/she viewed. Therefore, the user has a 70% chance of performing the same action on similar content. ii) For each action A and topic T, the probability p (U, A, T) of the user performing the action on an item associated with the topic. iii) For each action A and user V (e.g., an author who wrote a post/wiki page etc.), the probability p (U, A, V) of the user performing the action on content written by user V. In one embodiment, the profile for user U includes the probability for various tuples, e.g., action, topic and user V.

In some embodiments, given a specific post/content item, and an action such as like/dislike/share, biasing program 115 calculates a score based on the profile of the action performer, and the specific action taken on the content. For example, if the user performs the action often (i.e., p (U, A) is high), then biasing program 115 lowers the score accordingly. In another example, if the user performs the action rarely (i.e., p (U, A) is low), then biasing program 115 increases the score accordingly. In another example, if the content is associated with a certain topic T that the user often provides positive feedback for, higher p (U, A, T), then biasing program 115 lowers score. If the content is associated with topic T that has an associated area of expertise, then biasing program 115 uses the expertise score of U of the user with respect to topic T and increases the score proportionally (e.g., a higher level of expertise yields a higher score). If the content was created by user V, then a higher p (U, A, V) results in biasing program 115 lowering the determined score accordingly. If user V created the content, then the higher social distance between user U and user V results in a proportional increase in the score. For example, if user V, who in this example is a stranger to user U, indicates that they like the content of user U, then the “like” of user V counts more heavily in contrast to that of a “like” provided by a friend of user U.

In one embodiment, the profile for user U includes specific behavioral patterns. For example, the profile includes a logical argument that predicts that User 1 will like User 2's content based a history of User 1 indicating that they like the majority of User 2's content. In this example, there is a direct correlation between what is predicted to be liked by user 1 based on the history of user 1 liking something. In another example, the profile includes a logical argument that predicts that User 1 dislike food topics published by User 3 based a history of User 1 has indicating that they dislike User 3's recipes. In this example, there is an indirect correlation between what is predicted to be disliked by user 1 based on the history of user 1 disliking something that is related to the content. In this case, there is a relationship between food topics and recipes since they both pertain to food. However, they are not the same thing.

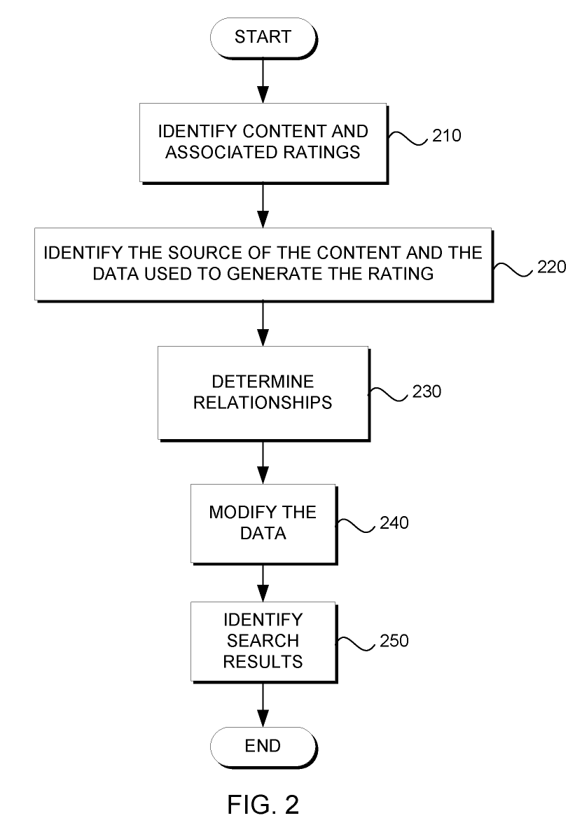

FIG. 2 illustrates operational processes of biasing program 115, executing on computing device 110 within the environment of FIG. 1, in accordance with an exemplary embodiment of the present invention.

In process 210, biasing program 115 identifies a particular content and its associated rating, i.e. feedback regarding the content. For ease of understanding, an example will be used throughout the following discussion. In this exemplary embodiment, biasing program 115 is included as part of a social media website. In this example, biasing program 115 identifies that a recipe on a social media website has a star rating associated with it.

In process 220, biasing program 115 identifies the source of the content and the data used to generate the rating. For example, biasing program 115 identifies that the recipe is included in content provided by user U. Biasing program 115 also identifies all of the users (V1 and V2) who have given their vote to indicate the overall star rating for that recipe on the social media site. Biasing program 115 also identifies the individual vote associated with each of the users V1 and V2. In one example, the users who have contributed to a given rating are identified in metadata associated with the overall rating for the content. Biasing program 115 accesses this information and generates a list of those users.

In process 230, biasing program 115 determines the relationships. In this example, the relationships are between user U and each of the users V1 and V2. Using the users identified in process 220, biasing program 115 applies at least some of the rules in biasing rules 117 to determine the type of relationship between the user U and each of the users V1 and V2. In one embodiment, biasing program 115 retrieves respective user profiles for user U and each of the users V1 and V2.

In one such embodiment, the respective profiles indicate the relationships between the users V1, V2, and user U. In another embodiment, biasing program 115 identifies the relationships between the users V1, V2, and user U by creation of a node array where at least some nodes represent the users V1, V2 and user U. Then, biasing program 115 determines the distance between the users V1, V2, and user U and bases a strength of their respective relationships on that distance.

For example, biasing program 115 determines that user V1 is a friend of user U based on an indicated friendship included in social media. Therefore the distance in the node array is one and biasing program 115 applies a set of rules used for close friends, which are included as part of biasing rules 117. In another example, biasing program 115 determines that user V2 is a distant acquaintance of user U based on i) a lack of indicated friendship included in social media, and ii) a common affiliation with a sports club from two years past. Therefore the distance in the node array is three and biasing program 115 applies a set of rules used for distant acquaintances, which are included as part of biasing rules 117.

In process 240, biasing program 115 modifies the data used to generate the rating for the content (for example, the ratings provided by each of the users V1 and V2) using biasing rules 117. The type and degree of modification is dependent of both i) the identified type of relationship between user U and user V1 and V2, and ii) the historical ratings associated with users V1 and V2.

For example, biasing program 115 identifies for user V1 a historical pattern of giving recipes high ratings regardless of the average indicated quality of the recipe. Further, biasing program 115 determines that user V1 does not like to cook based on indications included in their social media site, e.g., user V1 left a comment indicating that they dislike cooking. In contrast, biasing program 115 determines that user V2 attended culinary school.

As such, using rules included in biasing rules 117, biasing program 115 determines the new rating for the content, i.e., the recipe. In this example biasing program 115 i) reduces the weighted value associated with the star rating left by user V1, i.e., the star rating left by user V1 is counted for less when determining the overall rating for the recipe and, ii) increases the weighted value associated with the star rating left by user V2, i.e., the star rating left by user V2 is counted for less when determining the overall rating for the recipe.

In this example, biasing program 115 determines that user V1 is likely going to give a high rating to content posted by their close friend user U. Further, biasing program 115 determines that user V1 is likely going to give a high rating to recipes based on a history of giving high ratings to recipes. Lastly, biasing program 115 determines that user V1 has a low level of expertise related to recipes. In all three of these instances, biasing program 115 predicts that user V1 will give a high star rating to the recipe based on their predicted behavioral pattern.

In contrast, biasing program 115 determines that user V2 has a history of providing a wide variety of ratings for various recipes. In addition, biasing program 115 determines that user V2 has a low likelihood of having their rating be influenced by their relationship with user U. Finally, biasing program 115 determines that user V2 has an exceptionally high level of expertise regarding recipes since they attended culinary school. In all three of these instances, biasing program 115 predicts that user V2 will give a low star rating to the recipe based on their predicted behavioral pattern.

In this example, biasing program 115 counts the rating from user V1 as being equivalent to a three star rating, which is in contrast to the actual five star rating submitted by user V1. Note that the high star rating submitted for the recipe by user V1 was predicted using three separate approaches, i.e., predicted behavioral patterns. As such, since it was predicted, the rating is valued to a lesser degree by biasing program 115. In contrast, a four star rating for the recipe from user V2 was not predicted by biasing program 115 based on the predicted behavioral patterns of user V2. As such, biasing program 115 counts the rating of four stars from user V2 as being equivalent to a seven star rating, which exceeds the five star maximum rating that is otherwise possible but is actually a result of the heavier weight assigned to the rating of user V2.

The net result is an increase in the overall star rating of the recipe from a three and a half star rating to a four and a quarter star rating.

In process 250, biasing program 115 identifies search results for highly rates recipes included in the social media content. This search includes a filter to show recipes that have a four star or better rating. Note that without the adjustment of the star rating in process 240, the recipe would not be returned as a search result. However, due to the adjustment of the recipe rating in process 240, the recipe is identified as satisfying the criteria of the search and is returned as a result. In some embodiment, the search results are returned with an indication of which ratings have been adjusted over a threshold. For example, a recipe has a rating that is increases by two stars and another recipe has a rating that is decreased by one tenth of a star. The recipe that has a rating that is increases by two stars is indicated with a flag since the rating was adjusted beyond a threshold of one-half a star.

FIG. 3 depicts a block diagram, 300, of components of computing device 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Biasing program 115 and user data 125 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 130. In these examples, communications unit 310 includes one or more network interface cards. Communications unit 310 may provide communications through the use of either or both physical and wireless communications links. Biasing program 115 and user data 125 may be downloaded to persistent storage 308 through communications unit 310.

I/O interface(s) 312 allows for input and output of data with other devices that may be connected to computing device 110. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., biasing program 115 and user data 125, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

In various embodiments, biasing program 115 determines a predicted pattern of behavior of a user that provided a portion of data used to generate an initial rating of a content. In various embodiments, biasing program 115 generates a modified rating of the content based, at least in part, on a degree of matching between the predicted pattern of behavior of the user and an action of the user that provided the portion of data. Advantageously, a known pattern of behavior can be used to predict the actions of the user associated with that pattern of behavior. Advantageously, the effect of bias on a rating associated with a particular content that is generated based, at least in part, on the actions of the user, which were also predicted, can be reduced. It is to be noted that that some embodiments may not have these potential advantages and these potential advantages are not necessarily required of all embodiments.

In some embodiments, biasing program 115 generates a modified rating of a content has a lower degree of bias when compared to a degree of bias inherent to the initial rating of the content. Advantageously, reduction in a degree of bias for a rating of a content increases the accuracy of that rating and in some cases increases the reliability of that rating. In some embodiments, ratings with a higher degree of accuracy and/or reliability have the advantage of increasing the likelihood of returning a search result that provides the content being searched for by a user. It is to be noted that that some embodiments may not have these potential advantages and these potential advantages are not necessarily required of all embodiments.

In some embodiments, biasing program 115 generates a predicted pattern of behavior of the user based on one or more of i) a social relationship of the user, ii) a level of expertise of the user, and iii) a history of behavior of the user regarding a second content. Advantageously, such embodiments use a history of activity, social relationships, and expertise of a user to identify a degree of bias associated with an action of a user that is associated with a particular content. This advantageously allows the resulting degree of bias to be determined on specific attributes of a particular user. It is to be noted that that some embodiments may not have these potential advantages and these potential advantages are not necessarily required of all embodiments.

In some embodiments, biasing program 115 determines a search result based, at least in part, on a modified rating of content. Advantageously, some such embodiments provide search results that are not identified during a search based on content that has an un-modified rating, i.e., the original rating based on user actions. Advantageously, some such embodiments provide an order of search results that is different from the order of search results that is based on content that has an un-modified rating, i.e., an order of search results using the original rating based on user actions.

In some embodiments, biasing program 115 generates a visual indication of a degree of difference, i.e., the amount of difference, between the modified rating of content and an initial rating of that content. In some such embodiments, biasing program 115 displays the visual indication as part of a search result that includes that content. For example, a search result shows that a content has a modified rating and a percentage indicating that an initial rating for that content has been modified by that percentage. Advantageously, some such embodiments provide, to a user viewing the search results, one or both of i) an indication as to the degree that a rating has been modified and ii) how the order of search results may have been altered as a result of the modified ratings of the search results. In another embodiment, the visual indication is a colored shape. As the degree of modification of the initial rating for the content increases, the color of the shape changes in a corresponding manner. Advantageously, some such embodiments provide a means to visually assess the degree of change in a rating, i.e., how much the original rating was modified to generate the modified rating.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that certain term(s), such as, for example, “Smalltalk” and the like, may be subject to trademark rights in various jurisdictions throughout the world and are used here only in reference to the products or services properly denominated by the marks to the extent that such trademark rights may exist.

What is claimed is:

1. A method of reducing bias in a score of a content, the method comprising:
determining, by one or more processors, a predicted pattern of behavior of a user, the user having provided a portion of data used to generate an initial rating of a first content; and
generating, by the one or more processors, a modified rating of the first content based, at least in part, on a degree of matching between the predicted pattern of behavior of the user and an action of the user that provided the portion of data.

2. The method of claim 1, the method further comprising:
generating, by the one or more processors, the predicted pattern of behavior of the user based, at least in part, on one or more of i) a social relationship of the user, ii) a level of expertise of the user, and iii) a history of behavior of the user regarding a second content.

3. The method of claim 1, wherein the modified rating of the first content is generated based, at least in part, on an application of a weighted value to the portion of data.

4. The method of claim 1, the method including one or more of:
determining, by the one or more processors, a type of relationship between at least two of the user, an action performed by the user, and the content;
determining, by the one or more processors, a degree of bias that results from the type of relationship; and
generating, by the one or more processors, the modified rating of the first content based, at least in part, on the type of relationship.

5. The method of claim 1, wherein the modified rating of the first content has a lower degree of bias when compared to a degree of bias inherent to the initial rating of the first content.

6. The method of claim 1, the method further comprising:
determining, by the one or more processors, a search result based, at least in part, on the modified rating of the first content.

7. The method of claim 6, the method including:
displaying, by the one or more processors, both of the modified rating of the first content and the initial rating of the first content as part of the search result.

8. The method of claim 6, the method including:
generating, by the one or more processors, a visual indication of a degree of difference between the modified rating of the first content and the initial rating of the first content; and
displaying, by the one or more processors, the visual indication as part of the search result.
